(19) United States
(12) Patent Application Publication
(10) Pub. No.: US 2010/0324189 A1
(43) Pub. Date: Dec. 23, 2010

(54) SYSTEM FOR COMPRISING AT LEAST ONE EXTRUDED OR INJECTION MOULDED PART, METHOD FOR THE PRODUCTION THEREOF AND USE OF THE SAME

(75) Inventors: Kay Michael Brockmüller, Neustadt (DE); Andreas Eipper, Osnabruck (DE); Florian Hennenberger, Heppenheim (DE); Mark Völkel, Ladenburg (DE); Angelika Homes, Laudenbach (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/866,829

(22) PCT Filed: Feb. 6, 2009
(86) PCT No.: PCT/EP09/51358

§ 371 Date: Aug. 9, 2010

(30) Foreign Application Priority Data
Feb. 8, 2008 (DE) 10 2008 008 343.7
Jun. 5, 2008 (EP) 08157627.4

(51) Int. Cl. C08L 69/00; B29C 47/02; C08L 77/00; C08K 3/10

(52) U.S. Cl. 524/413; 524/537; 156/244.13; 524/502; 525/433

(57) ABSTRACT

The invention relates to a system (1) comprising at least one extruded or injection-molded molding (5) composed of a molding composition comprising a polymer material, where the molding composition comprises at least one filler for reinforcement. The proportion of the filler for reinforcement in the molding composition is in the range from 20 to 80% by weight. The invention further relates to a process for the production of a system (1), where the molding composition comprising the at least one filler for reinforcement is molded through an extrusion process to give the molding (5). The invention further relates to a use of the system (1).

The invention is based on a system comprising at least one extruded or injection-molded molding composed of a molding composition comprising a polymer material, where the molding composition comprises at least one filler for reinforcement. The invention further relates to a process for the production of such a system, and to the use of such a system.

For the production of systems comprising at least one extruded or injection-molded molding, use is generally made of extrusion processes. In this connection, extruders are particularly used for the production of continuous profiles. Polymer material is melted in an extruder and molded under pressure through a die to give an extruded profile. Particularly in the production of extruded profiles composed of reinforced polymers, it is also conventional to use what are known as pultrusion processes. In these, the molding of the extruded profile is promoted by an appropriate die, in that the extruded profile is drawn through the die on the side facing away from the plastification unit, for example the extruder.

Extruded profiles composed of polymer materials are used by way of example as supports, cable trunking, reinforcing sheets, door jambs or window mullions, door stiles, window sills, trackways, doorstops, sash windows, frames, including door frames and window frames, wall panels and ceiling panels, and furniture.

A particular requirement in the production of polymer profiles for applications in which the polymer profiles are subject to pressure forces or to bending forces, is that the profiles are reinforced so that they comply with the static requirements.

Profiles used for the production of doors and of windows are generally manufactured from polyvinyl chloride. These profiles are generally hollow-chamber profiles which in each case comprise at least one reinforcement chamber to receive a stiffener profile. Examples of a reinforcing profile used are steel profiles or aluminum profiles, or else profiles composed of fiber-reinforced plastic. By way of example, DE-A 197 36 393 discloses that steel stiffener profile or aluminum stiffener profile, or stiffener profile composed of fiber-reinforced plastic, can be inserted into the stiffener chamber of the plastics profile. However, use of steel profiles or of aluminum profiles has the disadvantage that these have a coefficient of thermal expansion different from that of the polymer material used. A further disadvantage is that the reinforcing profiles have to be inserted with precise fit into the plastics profile, to serve their function.

As an alternative, it is also known by way of example from EP-B 0 747 205 that fiber-reinforced materials can be directly molded to give components. By virtue of the fiber reinforcement, these intrinsically have increased strength. In the case of the process disclosed in EP-B 0 747 205, a composite composed of about 60 parts of PVC and 40 parts of fiber is first passed through an extruder. The molding composition is forced through a molding die and drawn by a take-off apparatus through a calibrator. In the calibrator the extrudate is cooled. The take-off apparatus for the extrudate is followed by a pultrusion die. Continuous fiber strands wetted by a thermoset pass within the pultrusion die, so that these are applied to the extrudate composed of the PVC/fiber composite. The fiber-reinforced thermoplastic core merely provides apparent enhancement of the thermoset layer. The reinforcement results from the combination of fiber-reinforced thermoplastic and the external layer composed of the fiber-reinforced thermoset.

Extrusion of fiber-reinforced thermoplastics without a take-off apparatus is disclosed by way of example in EP-B 0 820 848. Here, a composite material which comprises at most 15% by volume of fibers is molded through a standard extrusion apparatus to give an extruded profile. A suitable polymer mentioned is a crystalline polymer with low melt viscosity. The low proportion of at most 15% by volume of fibers is, however, not generally sufficient to provide adequate reinforcement of the types of profiles used by way of example in doors or in windows.

A profile strip in particular for the production of frames for windows or doors, is also disclosed in DE-A 32 02 918. Here, a core profile is produced from a glassfiber-reinforced polyvinyl chloride composition. This comprises up to 50% by weight of glass fibers. The core profile is bonded to a sheath composed of a polyvinyl-chloride-compatible plastic with impact resistance superior to that of the core profile. The method described for production of the core profile requires substantially greater lubricant addition in comparison with non-reinforced PVC.

It is an object of the present invention to provide a system which comprises at least one extruded or injection-molded molding composed of a polymer material, which meets the requirements placed upon mechanical strength for components used for reinforcement.

The object is achieved through a system comprising at least one extruded or injection-molded molding composed of a molding composition comprising a polymer material, where the molding composition comprises at least one filler. The proportion of the filler for reinforcement in the polymer material is in the range from 10 to 80% by weight. The proportion of filler is preferably in the range from 20 to 70% by weight, particularly preferably in the range from 30 to 65% by weight.

By virtue of the high proportion of filler in the polymer material, in comparison with the profile systems known from the prior art, the strength achieved is higher than that of the known systems. The high strength of the systems of the invention make them suitable, for example, for the reinforcement of profiles used for the production of frames, e.g. for solar collectors, for boards, for display screens, for windows, or for doors. Frames for windows and doors in this context are not only window frames and door frames but also window- and door-leaf frames. Other profiles exposed to large pressure forces or large bending forces can also be reinforced by the system of the invention, examples being shelving profiles or profiles for frameworks.

The polymer material used for the molding is preferably a thermoplastic. An advantage of a thermoplastic is that by way of example a plurality of moldings can be welded to one another. This permits stable bonding of individual moldings. An example of a possibility is then welding of the reinforcement if the system is used as reinforcement in frames for windows or doors. This leads to an additional improvement in stiffening of the frame.

The thermoplastic has preferably been selected from the group consisting of polyester, e.g. polyethylene terephthalate (PET), polytrimethylene terephthalate (PTT), polybutylene terephthalate (PBT); polyethylene naphthalate (PEN); polyamide (PA), in particular PA6.6; polyvinyl chloride (PVC), polyvinylidene chloride (PVdC), polypropylene (PP), polycarbonate (PC), styrene-acrylonitrile copolymer (SAN), acrylonitrile-butadiene-styrene copolymer (ABS), acrylonitrile-styrene-acrylate (ASA), polyoxymethylene (POM).

The thermoplastic is particularly preferably a thermoplastic polyester. The polyesters generally used here are those based on aromatic dicarboxylic acids and on an aliphatic or aromatic dihydroxy compound.

A first group of preferred polyesters is that of polyalkylene terephthalates, in particular those having from 2 to 10 carbon atoms in the alcohol moiety.

Polyalkylene terephthalates of this type are known per se and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl groups, such as methyl, ethyl, iso- or n-propyl, or n-, iso- or tert-butyl groups.

These polyalkylene terephthalates may be prepared by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexane-diol, 1,4-cyclohexanediol, 1,4-cyclohexanedimethanol and neopentyl glycol, and mixtures of these.

Particularly preferred polyesters are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The viscosity number of the polyesters is generally in the range from 50 to 220, preferably from 80 to 160 (measured in 0.5% strength by weight solution in a phenol/o-dichlorobenzene mixture (in a ratio by weight of 1:1 at 25° C.) in accordance with ISO 1628).

Particular preference is given to polyesters whose carboxy end group content is up to 100 meq/kg of polyester, preferably up to 50 meq/kg of polyester and in particular up to 40 meq/kg of polyester. Polyesters of this type may be prepared, for example, by the process of DE-A 44 01 055. The carboxy end group content is usually determined by titration methods e.g. potentiometry.

It is particularly preferable to use a mixture composed of polyesters other than PBT, for example polyethylene terephthalate (PET). The proportion of the polyethylene terephthalate, for example, in the mixture is preferably up to 50% by weight, in particular from 10 to 35% by weight, based on 100% by weight of polyester.

It is also advantageous to use recycled PET materials (also termed scrap PET), if appropriate mixed with polyalkylene terephthalates, such as PBT.

Recycled materials are generally:
1) those known as post-industrial recycled materials: these are production wastes during polycondensation or during processing, e.g. sprues from injection molding, start-up material from injection molding or extrusion, or edge trims from extruded sheets or foils,
2) post-consumer recycled materials: these are plastic items which are collected and treated after utilization by the end consumer. Blow-molded PET bottles for mineral water, soft drinks and juices are easily the predominant items in terms of quantity.

Both types of recycled material may be either in the form of regrind, or in the form of pellets. In the latter case, the crude recycled materials are separated and purified and then melted and pelletized using an extruder. This usually facilitates handling and free flow, and metering for further steps in processing.

The recycled materials used may be either pelletized or in the form of regrind. The edge length should not be more than 10 mm, preferably less than 8 mm.

Because polyesters undergo hydrolytic cleavage during processing, for example caused by traces of moisture, it is advisable to predry the recycled material. The residual moisture content after drying is preferably <0.2%, in particular <0.05%.

Another group to be mentioned is that of fully aromatic polyesters derived from aromatic dicarboxylic acids and aromatic dihydroxy compounds.

Suitable aromatic dicarboxylic acids are the compounds previously described for the polyalkylene terephthalates. The mixtures preferably used are composed of from 5 to 100 mol % of isophthalic acid and from 0 to 95 mol % of terephthalic acid, in particular from about 50 to about 80% of terephthalic acid and from about 20 to about 50% of isophthalic acid.

The aromatic dihydroxy compounds preferably have the general formula

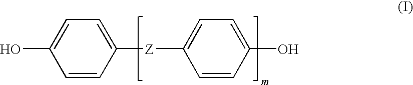

where Z is an alkylene or cycloalkylene group having up to 8 carbon atoms, an arylene group having up to 12 carbon atoms, a carbonyl group, a sulfonyl group, an oxygen or sulfur atom, or a chemical bond, and m is from 0 to 2. The phenylene groups of the compounds may also have substitution by C₁-C₆-alkyl or alkoxy groups and fluorine, chlorine or bromine.

Examples that may be mentioned of parent compounds for these compounds are dihydroxybiphenyl, di(hydroxyphenyl)alkane, di(hydroxyphenyl)cycloalkane, di(hydroxyphenyl)sulfide, di(hydroxyphenyl)ether, di(hydroxyphenyl)ketone, di(hydroxyphenyl)sulfoxide, α,α′-di(hydroxyphenyl)dialkylbenzene, di(hydroxyphenyl)sulfone, di(hydroxybenzoyl)benzene, resorcinol, and hydroquinone, and also the ring-alkylated and ring-halogenated derivatives of these.

Among these, preference is given to 4,4′-dihydroxybiphenyl, 2,4-di(4′-hydroxyphenyl)-2-methylbutane, α,α′-di(4-hydroxyphenyl)-p-diisopropylbenzene, 2,2-di(3′-methyl-4′-hydroxyphenyl)propane, and 2,2-di(3′-chloro-4′-hydroxyphenyl)propane, and in particular to 2,2-di(4′-hydroxyphenyl)propane, 2,2-di(3′,5-dichlorodihydroxyphenyl)-propane, 1,1-di(4′-hydroxyphenyl)cyclohexane, 3,4′-dihydroxybenzophenone, 4,4′-dihydroxydiphenyl sulfone and 2,2-di(3′,5′-dimethyl-4′-hydroxyphenyl)propane and mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in US-A 3 651 014. Corresponding products are also available commercially, e.g. Hytrel® (DuPont).

Other polyesters according to the invention are halogen-free polycarbonates. Examples of suitable halogen-free polycarbonates are those based on diphenols of the general formula (II)

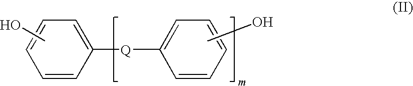

where Q is a single bond, a C₁-C₈-alkylene, C₂-C₃-alkylidene, C₃-C₆-cycloalkylidene, or C₆-C₁₂-arylene group, or —O—, —S— or —SO₂—, and m is a whole number from 0 to 2.

The phenylene radicals of the diphenols may also have substituents, such as C₁-C₆-alkyl or C₁-C₆-alkoxy.

Examples of preferred diphenols of the formula (II) are hydroquinone, resorcinol, 4,4′-dihydroxybiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as polymer material, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the diphenols used, of at least trifunctional compounds, for example those having three or more phenolic OH groups.

Polycarbonates which have proven particularly suitable have relative viscosities nᵣₑₗ of from 1.10 to 1.50, in particular from 1.25 to 1.40. This corresponds to an average molar mass M_{w}, (weight-average) of from 10 000 to 200 000 g/mol, preferably from 20 000 to 80 000 g/mol.

The diphenols of the general formula (II) are known per se or can be prepared by known processes:

The polycarbonates may, for example, be prepared by reacting the diphenols with phosgene in the interfacial process, or with phosgene in the homogeneous-phase process (known as the pyridine process), and in each case the desired molecular weight is achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol as in DE-A 28 42 005, or monoalkylphenols, or dialkylphenols with a total of from 8 to 20 carbon atoms in the alkyl substituents as in DE-A-35 06 472, such as p-nonylphenol, 3,5-di-tert-butylphenol, p-tert-octylphenol, p-dodecylphenol, 2-(3,5-dimethylheptyl)phenol and 4-(3,5-dimethyl-heptyl)phenol.

For the purposes of the present invention, halogen-free polycarbonates are poly-carbonates composed of halogen-free diphenols, of halogen-free chain terminators and, if used, halogen-free branching agents, where the content of subordinate amounts at the ppm level of hydrolyzable chlorine, resulting, for example, from the preparation of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable polymer materials which may be mentioned are amorphous polyester carbonates, where during the preparation process phosgene has been replaced by aromatic dicarboxylic acid units, such as isophthalic acid and/or terephthalic acid units. Reference may be made at this point to EP-A 711 810 for further details.

EP-A 365 916 describes other suitable copolycarbonates having cycloalkyl radicals as monomer units.

It is also possible for bisphenol A to be replaced by bisphenol TMC. Polycarbonates of this type are obtainable from Bayer with the trademark APEC HAT®.

Alongside abovementioned polyesters, PA6.6 is particularly preferred as polymer material. PA6.6 is advantageous in exhibiting good coupling to glass fiber. PA6.6 also has high stiffness and, when used in a hollow profile composed of PVC, has good adhesion to the PVC.

The filler for reinforcement can take the form of fiber or of particles. By way of example, carbon fibers, glass fibers, glass beads, amorphous silica, asbestos, calcium silicate, calcium metasilicate, magnesium carbonate, kaolin, chalk, powdered quartz, mica, barium sulfate, and feldspar can be used.

To achieve adequate reinforcement, in particular adequate tensile strength and, respectively, compressive strength, it is preferable that the filler for reinforcement takes the form of fibers.

Preferred fibrous fillers are glass fibers, carbon fibers, aramid fibers, and potassium titanate fibers. Particular preference is given here to glass fibers. The fibrous fillers can be used in the form of rovings, mats, or chopped glass in the commercially available forms.

The fibers are particularly preferably used in the form of short fibers, their length usually being in the range from 0.1 to 0.4 mm. The diameter of the fibers is preferably in the range from 5 to 20 μm.

To improve compatibility with the thermoplastic, the fillers for reinforcement can have been surface-pretreated with a silane compound.

Suitable silane compounds are those of the general formula

(X—(CH₂)ₙ)ₖ—Si—(O—CₘH₂ₘ₊₁)₄₋ₖ

in which the substituents are as follows:

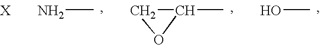

n is a whole number from 2 to 10, preferably from 3 to 4
m is a whole number from 1 to 5, preferably from 1 to 2
k is a whole number from 1 to 3, preferably 1.

Preferred silane compounds are aminopropyltrimethoxysilane, aminobutyl-trimethoxysilane, aminopropyltriethoxysilane, aminobutyltriethoxysilane, and also the corresponding silanes which comprise a glycidyl group as substituent X.

The amounts generally used of the silane compounds are from 0.05 to 5% by weight, preferably from 0.5 to 1.5% by weight, and in particular from 0.8 to 1% by weight, based on the weight of the filler. Alongside the fibrous or particulate fillers mentioned, mineral fillers are also suitable.

The mineral filler can, if appropriate, have been pretreated with the above-mentioned silane compounds. However, the pretreatment is not essential.

Further fillers that may be mentioned are kaolin, calcined kaolin, wollastonite, talc, and chalk.

To improve the processability of the polymer material which comprises at least one filler for reinforcement, in particular to improve extrudability, the polymer material comprising the at least one filler for reinforcement also comprises at least one highly branched or hyperbranched polycarbonate with an OH number of from 1 to 600 mg KOH/g of polycarbonate, at least one highly branched or hyperbranched polyester of AₓB_{y} type, where x is at least 1.1 and y is at least 2.1, or a mixture of these.

By virtue of the highly branched or hyperbranched polycarbonate and, respectively, the highly branched or hyperbranched polyester, incipient melting of the polymer material comprising the at least one filler is achieved more rapidly. Another result is improved bonding. By way of example, this permits better welding of moldings composed of the polymer material comprising the at least one filler for reinforcement.

The polymer material comprising the at least one filler for reinforcement preferably comprises at least one highly branched or hyperbranched polycarbonate with an OH number of from 1 to 600 mg KOH/g of polycarbonate, preferably from 10 to 550 mg KOH/g of polycarbonate, and in particular from 50 to 550 mg KOH/g of polycarbonate (to DIN 53240, Part 2), or at least one hyperbranched polyester, or a mixture of these.

For the purposes of this invention, highly branched or hyperbranched polycarbonates are uncrosslinked macromolecules having hydroxy and carbonate groups, these having both structural and molecular non-uniformity. Their structure may firstly be based on a central molecule by analogy with dendrimers, but with non-uniform chain length of the branches. Secondly, they may also have a linear structure with functional pendent groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30 for the definition of “degree of branching”.

The DB (degree of branching) of the relevant substances is defined as

$$DB = \frac{T + Z}{T + Z + L} \times 100 \% ,$$

where T is the average number of terminal monomer units, Z is the average number of branched monomer units, and L is the average number of linear monomer units in the macromolecules of the respective substances.

The highly branched or hyperbranched polycarbonate preferably has a number-average molar mass Mₙ, of from 100 to 15 000 g/mol, preferably from 200 to 12 000 g/mol, and in particular from 500 to 10 000 g/mol (GPC, PMMA standard).

The glass transition temperature Tg is in particular from −80° C. to +140° C., preferably from −60 to 120° C. (according to DSC, DIN 53765).

Viscosity at 23° C. is preferably in the range from 50 to 200 000 mPas, in particular in the range from 100 to 150 000 mPas, and very particularly preferably in the range from 200 to 100 000 mPas.

The highly branched or hyperbranched polycarbonate is preferably obtainable via a process which comprises at least the following steps:
a) reaction of at least one organic carbonate of the general formula RO[(CO)]ₙOR with at least one aliphatic, aliphatic/aromatic or aromatic alcohol which has at least 3 OH groups, with elimination of alcohols ROH to give one or more condensates, where each R, independently of the others, is a straight-chain or branched aliphatic, aromatic/aliphatic or aromatic hydrocarbon radical having from 1 to 20 carbon atoms, and where the radicals R may also have bonding to one another to form a ring, and n is a whole number from 1 to 5, or
ab) reaction of phosgene, diphosgene, or triphosgene with an aliphatic, aliphatic/aromatic, or aromatic alcohol which has at least 3 OH groups, with elimination of hydrogen chloride, and
b) intermolecular reaction of the condensates to give a highly functional, highly branched, or highly functional, hyperbranched polycarbonate,
   where the quantitative proportion of the OH groups to the carbonates in the reaction mixture is selected in such a way that the condensates have an average of either one carbonate group and more than one OH group or one OH group and more than one carbonate group.

Phosgene, diphosgene, or triphosgene may be used as starting material, but preference is given to organic carbonates.

Each of the radicals R of the organic carbonates used as starting material and having the general formula RO(CO)OR is, independently of the others, a straight-chain or branched aliphatic, aromatic/aliphatic or aromatic hydrocarbon radical having from 1 to 20 carbon atoms. The two radicals R may also have bonding to one another to form a ring. The radical is preferably an aliphatic hydrocarbon radical, and particularly preferably a straight-chain or branched alkyl radical having from 1 to 5 carbon atoms, or a substituted or unsubstituted phenyl radical.

In particular, use is made of simple carbonates of the formula RO(CO)ₙOR; n is preferably from 1 to 3, in particular 1.

By way of example, dialkyl or diaryl carbonates may be prepared from the reaction of aliphatic, araliphatic, or aromatic alcohols, preferably monoalcohols, with phosgene. They may also be prepared by way of oxidative carbonylation of the alcohols or phenols by means of CO in the presence of noble metals, oxygen, or NOₓ. In relation to preparation methods for diaryl or dialkyl carbonates, see also “Ullmann's Encyclopedia of Industrial Chemistry”, 6th edition, 2000 Electronic Release, Verlag Wiley-VCH.

Examples of suitable carbonates comprise aliphatic, aromatic/aliphatic or aromatic carbonates, such as ethylene carbonate, propylene 1,2- or 1,3-carbonate, diphenyl carbonate, ditolyl carbonate, dixylyl carbonate, dinaphthyl carbonate, ethyl phenyl carbonate, dibenzyl carbonate, dimethyl carbonate, diethyl carbonate, dipropyl carbonate, dibutyl carbonate, diisobutyl carbonate, dipentyl carbonate, dihexyl carbonate, dicyclohexyl carbonate, diheptyl carbonate, dioctyl carbonate, didecyl carbonate, or didodecyl carbonate.

Examples of carbonates where n is greater than 1 comprise dialkyl dicarbonates, such as di(tert-butyl)dicarbonate, or dialkyl tricarbonates, such as di(tert-butyl)tricarbonate.

It is preferable to use aliphatic carbonates, in particular those in which the radicals comprise from 1 to 5 carbon atoms, e.g. dimethyl carbonate, diethyl carbonate, dipropyl carbonate, dibutyl carbonate, or diisobutyl carbonate.

The organic carbonates are reacted with at least one aliphatic alcohol which has at least 3 OH groups, or with mixtures of two or more different alcohols.

Examples of compounds having at least three OH groups comprise glycerol, trimethylolethane, trimethylolethane, trimethylolpropane, 1,2,4-butanetriol, tris(hydroxymethyl)amine, tris(hydroxyethyl)amine, tris(hydroxypropyl)amine, pentaerythritol, diglyceryl, triglyceryl, polyglycerols, bis(trimethylolpropane), tris(hydroxymethyl)isocyanurate, tris(hydroxyethyl)isocyanurate, phloroglucinol, trihydroxytoluene, trihydroxydimethylbenzene, phloroglucides, hexahydroxybenzene, 1,3,5-benzenetrimethanol, 1,1,1-tris(4′-hydroxyphenyl)methane, 1,1,1-tris(4′-hydroxyphenyl)ethane, or sugars, e.g. glucose, trihydric or higher polyhydric polyetherols based on trihydric or higher polyhydric alcohols and ethylene oxide, propylene oxide, or butylene oxide, or polyesterols. Particular preference is given here to glycerol, trimethylolethane, trimethylolpropane, 1,2,4-butanetriol, pentaerythritol, and also their polyetherols based on ethylene oxide or propylene oxide.

These polyhydric alcohols may also be used in a mixture with dihydric alcohols, with the proviso that the average total OH functionality of all of the alcohols used is greater than 2. Examples of suitable compounds having two OH groups comprise ethylene glycol, diethylene glycol, triethylene glycol, 1,2- and 1,3-propanediol, dipropylene glycol, dipropylene glycol, neopentyl glycol, 1,2-, 1,3-, and 1,4-butanediol, 1,2-, 1,3-, and 1,5-pentanediol, hexanediol, cyclopentanediol, cyclohexanediol, cyclohexanedimethanol, bis(4-hydroxycyclohexyl)methane, bis(4-hydroxycyclohexyl)-ethane, 2,2-bis(4-hydroxycyclohexyl)propane, 1,1′-bis(4-hydroxyphenyl)-3,3,5-tri-methylcyclohexane, resorcinol, hydroquinone, 4,4′-dihydroxyphenyl, bis(4-bis(hydroxy-phenyl)sulfide, bis(4-hydroxyphenyl)sulfone, bis(hydroxymethyl)benzene, bis-(hydroxymethyl)toluene, bis(p-hydroxyphenyl)methane, bis(p-hydroxyphenyl)ethane, 2,2-bis(p-hydroxyphenyl)propane, 1,1-bis(p-hydroxyphenyl)cyclohexane, dihydroxy-benzophenone, dihydric polyether polyols based on ethylene oxide, propylene oxide, butylene oxide, or mixtures of these, polytetrahydrofuran, polycaprolactone, or polyesterols based on diols and dicarboxylic acids.

The diols serve for fine adjustment of the properties of the polycarbonate. If use is made of dihydric alcohols, the ratio of dihydric alcohols, to the at least trihydric alcohols is set by the person skilled in the art and depends on the desired properties of the polycarbonate. The amount of the dihydric alcohol(s) is generally from 0 to 39.9 mol %, based on the total amount of all of the dihydric and trihydric alcohols taken together. The amount is preferably from 0 to 35 mol %, particularly preferably from 0 to 25 mol %, and very particularly preferably from 0 to 10 mol %.

The reaction of phosgene, diphosgene, or diphosgene with the alcohol or alcohol mixture generally takes place with elimination of hydrogen chloride, and the reaction of the carbonates with the alcohol or alcohol mixture to give the inventive highly functional highly branched polycarbonate takes place with elimination of the monofunctional alcohol or phenol from the carbonate molecule.

The highly functional highly branched polycarbonates formed by the inventive process have termination by hydroxy groups and/or by carbonate groups after the reaction, i.e. with no further modification. They have good solubility in various solvents, e.g. in water, alcohols, such as methanol, ethanol, butanol, alcohol/water mixtures, acetone, 2-butanone, ethyl acetate, butyl acetate, methoxypropyl acetate, methoxyethyl acetate, tetrahydrofuran, dimethylformamide, dimethylacetamide, N-methylpyrrolidone, ethylene carbonate, or propylene carbonate.

For the purposes of this invention, a highly functional polycarbonate is a product which, besides the carbonate groups which form the polymer skeleton, further has at least three, preferably at least six, more preferably at least ten, terminal or pendent functional groups. The functional groups are carbonate groups and/or OH groups. There is in principle no upper restriction on the number of the terminal or pendent functional groups, but products having a very high number of functional groups can have undesired properties, such as high viscosity or poor solubility. The highly functional polycarbonates of the present invention mostly have not more than 500 terminal or pendent functional groups, preferably not more than 100 terminal or pendent functional groups.

When preparing highly branched or hyperbranched polycarbonates, it is necessary to adjust the ratio of the compounds comprising OH groups to phosgene or carbonate in such a way that the simplest resultant condensate comprises an average of either one carbonate group or carbamoyl group and more than one OH group or one OH group and more than one carbonate group or carbamoyl group. The simplest structure of the condensate composed of a carbonate and a di- or polyalcohol here results in the arrangement XYₙ or YₙX, where X is a carbonate group, Y is a hydroxy group, and n is generally a number from 1 to 6, preferably from 1 to 4, particularly preferably from 1 to 3. The reactive group which is the single resultant group here is generally termed “focal group” below.

By way of example, if during the preparation of the simplest condensate from a carbonate and a dihydric alcohol the reaction ratio is 1:1, the average result is a molecule of XY type, illustrated by the general formula (III).

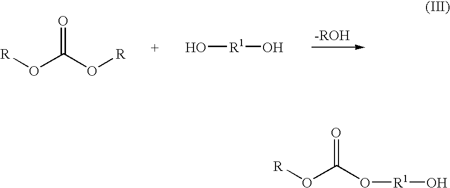

During the preparation of the condensate from a carbonate and a trihydric alcohol with a reaction ratio of 1:1, the average result is a molecule of XY₂ type, illustrated by the general formula (IV). A carbonate group is focal group here.

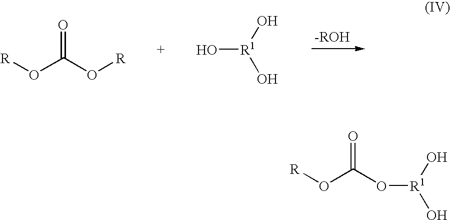

During the preparation of the condensate from a carbonate and a tetrahydric alcohol, likewise with the reaction ratio 1:1, the average result is a molecule of XY₃ type, illustrated by the general formula (V). A carbonate group is focal group here.

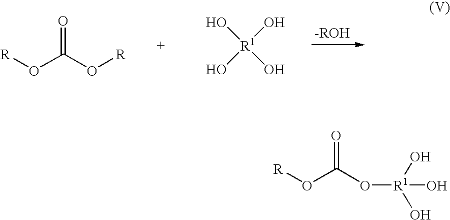

R in the formulae III to V has the definition given at the outset, and R¹ is an aliphatic or aromatic radical.

The condensate may, by way of example, also be prepared from a carbonate and a trihydric alcohol, as illustrated by the general formula VI, the molar reaction ratio being 2:1. Here, the average result is a molecule of X₂Y type, an OH group being focal group here. In formula VI, R and R¹ are as defined in formulae III to V.

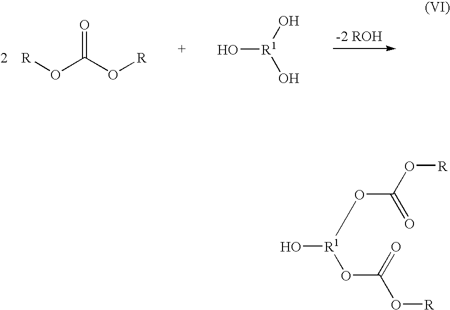

If difunctional compounds, e.g. a dicarbonate or a diol, are also added to the components, this extends the chains, as illustrated by way of example in the general formula VII. The average result is again a molecule of XY₂ type, a carbonate group being focal group.

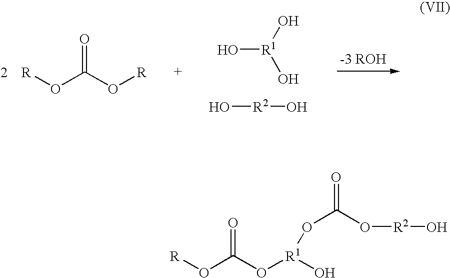

In formula VII, R² is an organic, preferably aliphatic radical, R and R¹ are as defined above.

It is also possible to use two or more condensates for the synthesis. Here, firstly two or more alcohols or two or more carbonates may be used. Furthermore, mixtures of various condensates of different structure can be obtained via the selection of the ratio of the alcohols used and of the carbonates or the phosgenes. This may be illustrated taking the example of the reaction of a carbonate with a trihydric alcohol. If the starting products are reacted in a ratio of 1:1, as shown formula in IV, the result is an XY₂ molecule. If the starting products are reacted in a ratio of 2:1, as shown in formula VI, the result is an X₂Y molecule. If the ratio is from 1:1 to 2:1, the result is a mixture of XY₂ and X₂Y molecules.

According to the invention, the simple condensates described by way of example in the formulae III to VII preferentially react intermolecularly to form highly functional polycondensates. The reaction to give the condensate and to give the polycondensate usually takes place at a temperature of from 0 to 250° C., preferably from 60 to 160° C., in bulk or in solution. Use may generally be made here of any of the solvents which are inert with respect to the respective starting materials. Preference is given to use of organic solvents, e.g. decane, dodecane, benzene, toluene, chlorobenzene, xylene, dimethylformamide, dimethylacetamide, or solvent naphtha.

In one preferred embodiment, the condensation reaction is carried out in bulk. To accelerate the reaction, the phenol or the monohydric alcohol ROH liberated during the reaction can be removed by distillation from the reaction equilibrium if appropriate at reduced pressure.

If removal by distillation is intended, it is generally advisable to use those carbonates which liberate alcohols ROH with a boiling point below 140° C. during the reaction.

Catalysts or catalyst mixtures may also be added to accelerate the reaction. Suitable catalysts are compounds which catalyze esterification or transesterification reactions, e.g. alkali metal hydroxides, alkali metal carbonates, alkali metal hydrogencarbonates, preferably of sodium, of potassium, or of cesium, tertiary amines, guanidines, ammonium compounds, phosphonium compounds, organoaluminum, organotin, organozinc, organotitanium, organozirconium, or organobismuth compounds, or else what are known as double metal cyanide (DMC) catalysts, e.g. as described in DE 10138216 or DE 10147712.

It is preferable to use potassium hydroxide, potassium carbonate, potassium hydrogencarbonate, diazabicyclooctane (DABCO), diazabicyclononene (DBN), diazabicycloundecene (DBU), imidazoles, such as imidazole, 1-methylimidazole, or 1,2-dimethylimidazole, titanium tetrabutoxide, titanium tetraisopropoxide, dibutyltin oxide, dibutyltin dilaurate, stannous dioctoate, zirconium acetylacetonate, or mixtures thereof.

The amount of catalyst generally added is from 50 to 10 000 ppm by weight, preferably from 100 to 5000 ppm by weight, based on the amount of the alcohol mixture or alcohol used.

It is also possible to control the intermolecular polycondensation reaction via addition of the suitable catalyst or else via selection of a suitable temperature. The average molecular weight of the polymer may moreover be adjusted by way of the composition of the starting components and by way of the residence time.

The condensates and the polycondensates prepared at an elevated temperature are usually stable at room temperature for a relatively long period.

The nature of the condensates permits polycondensates with different structures to result from the condensation reaction, these having branching but no crosslinking. Furthermore, in the ideal case, the polycondensates have either one carbonate group as focal group and more than two OH groups or else one OH group as focal group and more than two carbonate groups. The number of reactive groups here is the result of the nature of the condensates used and the degree of polycondensation.

By way of example, a condensate according to the general formula IV can react via triple intermolecular condensation to give two different polycondensates, represented in the general formulae VIII and IX.

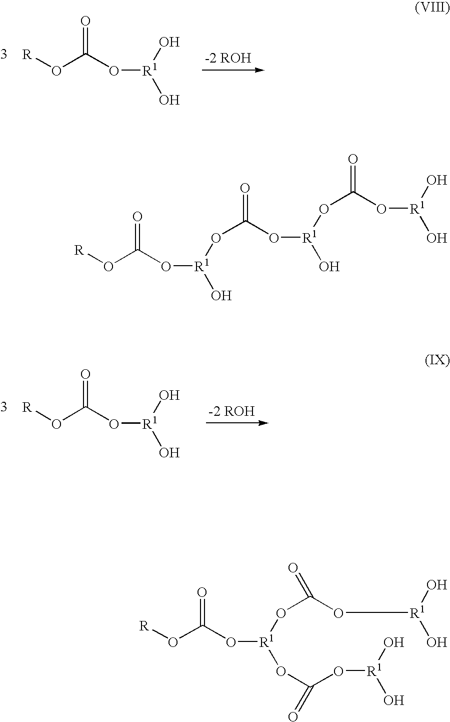

R and R¹ in formula VIII and IX are as defined above.

There are various ways of terminating the intermolecular polycondensation reaction. By way of example, the temperature may be lowered to a range where the reaction stops and the condensate or the polycondensate is storage-stable.

It is also possible to deactivate the catalyst, for example in the case of basic catalysts via addition of Lewis acids or proton acids.

In another embodiment, as soon as the intermolecular reaction of the condensate has produced a polycondensate with the desired degree of polycondensation, a product having groups reactive toward the focal group of the condensate may be added to the product to terminate the reaction. In the case of a carbonate group as focal group, by way of example, a mono-, di-, or polyamine may be added. In the case of a hydroxy group as focal group, by way of example, a mono-, di-, or polyisocyanate, or a compound comprising epoxy groups, or an acid derivative which reacts with OH groups, can be added to the polycondensate.

The inventive highly functional polycarbonates are mostly prepared in the pressure range from 0.1 mbar to 20 bar, preferably at from 1 bar to 5 bar, in reactors or reactor cascades which are operated batchwise, semicontinuously, or continuously.

The inventive products can be further processed without further purification after their preparation by virtue of the abovementioned adjustment of the reaction conditions and, if appropriate, by virtue of the selection of the suitable solvent.

In another preferred embodiment, the product is stripped, i.e. freed from low-molecular-weight, volatile compounds. For this, once the desired degree of conversion has been reached the catalyst may optionally be deactivated and the low-molecular-weight volatile constituents, e.g. monoalcohols, phenols, carbonates, hydrogen chloride, or volatile oligomeric or cyclic compounds, can be removed by distillation, if appropriate with introduction of a gas, preferably nitrogen, carbon dioxide, or air, if appropriate at reduced pressure.

In another preferred embodiment, the highly branched or hyperbranched polycarbonates may obtain other functional groups besides the functional groups present at this stage by virtue of the reaction. The functionalization may take place during the molecular weight increase, or else subsequently, i.e. after completion of the actual polycondensation.

Effects of this type can, by way of example, be achieved via addition, during the polycondensation, of compounds which bear other functional groups or functional elements, such as mercapto groups, primary, secondary or tertiary amino groups, ether groups, derivatives of carboxylic acids, derivatives of sulfonic acids, derivatives of phosphonic acids, silane groups, siloxane groups, aryl radicals, or long-chain alkyl radicals, besides hydroxy groups, carbonate groups or carbamoyl groups. Examples of compounds which may be used for modification by means of carbamate groups are ethanolamine, propanolamine, isopropanolamine, 2-(butylamino)ethanol, 2-(cyclohexyl-amino)ethanol, 2-amino-1-butanol, 2-(2′-aminoethoxy)ethanol or higher alkoxylation products of ammonia, 4-hydroxypiperidine, 1-hydroxyethylpiperazine, diethanolamine, dipropanolamine, diisopropanolamine, tris(hydroxymethyl)aminomethane, tris(hydroxy-ethyl)aminomethane, ethylenediamine, propylenediamine, hexamethylenediamine or isophoronediamine.

An example of a compound which can be used for modification with mercapto groups is mercaptoethanol. By way of example, tertiary amino groups can be produced via incorporation of N-methyldiethanolamine, N-methyldipropanolamine or N,N-dimethyl-ethanolamine. By way of example, ether groups may be generated via co-condensation of dihydric or higher polyhydric polyetherols. Long-chain alkyl radicals can be introduced via reaction with long-chain alkanediols, and reaction with alkyl or aryl diisocyanates generates polycarbonates having alkyl, aryl, and urethane groups, or urea groups.

Ester groups can be produced via addition of dicarboxylic acids, tricarboxylic acids, or, for example, dimethyl terephthalate, or tricarboxylic esters.

Subsequent functionalization can be achieved by using an additional step of the process to react the resultant highly functional highly branched, or highly functional hyperbranched polycarbonate with a suitable functionalizing reagent which can react with the OH and/or carbonate groups or carbamoyl groups of the polycarbonate.

By way of example, highly functional highly branched, or highly functional hyperbranched polycarbonates comprising hydroxy groups can be modified via addition of molecules comprising acid groups or isocyanate groups. By way of example, polycarbonates comprising acid groups can be obtained via reaction with compounds comprising anhydride groups.

Highly functional polycarbonates comprising hydroxy groups may moreover also be converted into highly functional polycarbonate polyether polyols via reaction with alkylene oxides, e.g. ethylene oxide, propylene oxide, or butylene oxide.

The polymer material can comprise, as highly branched or hyperbranched polyester, at least one hyperbranched polyester of AₓB_{y} type, where

x is at least 1.1, preferably at least 1.3, in particular at least 2
y is at least 2.1, preferably at least 2.5, in particular at least 3.

Use may also be made of mixtures as units A and/or B, of course.

An AₓB_{y}-type polyester is a condensate composed of an x-functional molecule A and a y-functional molecule B. By way of example, mention may be made of a polyester composed of adipic acid as molecule A (x=2) and glycerol as molecule B (y=3).

For the purposes of this invention, hyperbranched polyesters are non-crosslinked macromolecules having hydroxy groups and carboxy groups, these having both structural and molecular non-uniformity. Their structure may firstly be based on a central molecule in the same way as dendrimers, but with non-uniform chain length of the branches. Secondly, they may also have a linear structure with functional pendent groups, or else they may combine the two extremes, having linear and branched molecular portions. See also P. J. Flory, J. Am. Chem. Soc. 1952, 74, 2718, and H. Frey et al., Chem. Eur. J. 2000, 6, no. 14, 2499 for the definition of dendrimeric and hyperbranched polymers.

“Hyperbranched” in the context of the present invention means that the degree of branching (DB), i.e. the average number of dendritic linkages plus the average number of end groups per molecule, is from 10 to 99.9%, preferably from 20 to 99%, particularly preferably from 20 to 95%.

“Dendrimeric” in the context of the present invention means that the degree of branching is from 99.9 to 100%. See H. Frey et al., Acta Polym. 1997, 48, 30, and the formula given under B1) for the definition of “degree of branching”.

The highly branched or hyperbranched polyester preferably has an average molar mass of from 300 to 30 000 g/mol, in particular from 400 to 25 000 g/mol, and very particularly from 500 to 20 000 g/mol, determined by means of GPC, PMMA standard, dimethylacetamide eluent.

The highly branched or hyperbranched polyester preferably has an OH number of from 0 to 600 mg KOH/g of polyester, preferably from 1 to 500 mg KOH/g of polyester, in particular from 20 to 500 mg KOH/g of polyester, to DIN 53240, and also preferably has a COOH number of from 0 to 600 mg KOH/g of polyester, preferably from 1 to 500 mg KOH/g of polyester, in particular from 2 to 500 mg KOH/g of polyester.

The glass transition temperature T_{g} is preferably from −50° C. to 140° C., and in particular from −50° C. to 100° C. (by means of DSC, to DIN 53765).

Particular preference is given to highly branched or hyperbranched polyesters in which at least one OH number or, respectively, COON number is greater than 0, preferably greater than 0.1, and in particular greater than 0.5.

The highly branched or hyperbranched polyester is by way of example obtainable by reacting
(a) one or more dicarboxylic acids or one or more derivatives of the same with one or more at least trihydric alcohols
or
(b) one or more tricarboxylic acids or higher polycarboxylic acids or one or more derivatives of the same with one or more diols

in the presence of a solvent and optionally in the presence of an inorganic, organometallic, or low-molecular-weight organic catalyst, or of an enzyme. The reaction in solvent is the preferred preparation method.

For the purposes of the present invention, highly functional hyperbranched polyesters have molecular and structural non-uniformity. Their molecular non-uniformity distinguishes them from dendrimers, and they can therefore be prepared at considerably lower cost.

Among the dicarboxylic acids which can be reacted according to variant (a) are, by way of example, oxalic acid, malonic acid, succinic acid, glutaric acid, adipic acid, pimelic acid, suberic acid, azelaic acid, sebacic acid, undecane-α,ωdicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-di-carboxylic acid, cis- and trans-cyclopentane-1,2-dicarboxylic acid, and cis- and trans-cyclopentane-1,3-dicarboxylic acid,

where the abovementioned dicarboxylic acids may have substitution by one or more radicals selected from

C₁-C₁₀-alkyl groups, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl groups, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl;

alkylene groups, such as methylene or ethylidene, or

C₆-C₁₄-aryl groups, such as phenyl, 1-naphthyl, 2-naphthyl, 1-anthryl, 2-anthryl, 9-anthryl, 1-phenanthryl, 2-phenanthryl, 3-phenanthryl, 4-phenanthryl, and 9-phenanthryl, preferably phenyl, 1-naphthyl, and 2-naphthyl, particularly preferably phenyl.

Examples which may be mentioned as representatives of substituted dicarboxylic acids are: 2-methylmalonic acid, 2-ethylmalonic acid, 2-phenylmalonic acid, 2-methylsuccinic acid, 2-ethylsuccinic acid, 2-phenylsuccinic acid, itaconic acid, 3,3-dimethylglutaric acid.

Among the dicarboxylic acids which can be reacted according to variant (a) are also ethylenically unsaturated acids, such as maleic acid and fumaric acid, and aromatic dicarboxylic acids, such as phthalic acid, isophthalic acid or terephthalic acid.

It is also possible to use mixtures of two or more of the abovementioned representative compounds.

The dicarboxylic acids may either be used as they stand or be used in the form of derivatives.

Derivatives are preferably

the relevant anhydrides in monomeric or else polymeric form,

mono- or dialkyl esters, preferably mono- or dimethyl esters, or the corresponding mono- or diethyl esters, or else the mono- and dialkyl esters derived from higher alcohols, such as n-propanol, isopropanol, n-butanol, isobutanol, tert-butanol, n-pentanol, n-hexanol,

and also mono- and divinyl esters, and

mixed esters, preferably methyl ethyl esters.

In the preferred preparation process it is also possible to use a mixture composed of a dicarboxylic acid and one or more of its derivatives. Equally, it is possible to use a mixture of two or more different derivatives of one or more dicarboxylic acids.

It is particularly preferable to use succinic acid, glutaric acid, adipic acid, phthalic acid, isophthalic acid, terephthalic acid, or the mono- or dimethyl esters thereof. It is very particularly preferable to use adipic acid.

Examples of at least trihydric alcohols which may be reacted are: glycerol, butane-1,2,4-triol, n-pentane-1,2,5-triol, n-pentane-1,3,5-triol, n-hexane-1,2,6-triol, n-hexane-1,2,5-triol, n-hexane-1,3,6-triol, trimethylolbutane, trimethylolpropane or ditrimethylol-propane, trimethylolethane, pentaerythritol or dipentaerythritol; sugar alcohols, such as mesoerythritol, threitol, sorbitol, mannitol, or mixtures of the above at least trihydric alcohols. It is preferable to use glycerol, trimethylolpropane, trimethylolethane, and pentaerythritol.

Examples of tricarboxylic acids or polycarboxylic acids which can be reacted according to variant (b) are benzene-1,2,4-tricarboxylic acid, benzene-1,3,5-tricarboxylic acid, benzene-1,2,4,5-tetracarboxylic acid, and mellitic acid.

Tricarboxylic acids or polycarboxylic acids may be used in the inventive reaction either as they stand or else in the form of derivatives.

Derivatives are preferably
the relevant anhydrides in monomeric or else polymeric form,
mono-, di-, or trialkyl esters, preferably mono-, di-, or trimethyl esters, or the corresponding mono-, di-, or triethyl esters, or else the mono-, di-, and triesters derived from higher alcohols, such as n-propanol, isopropanol, n-butanol, isobutanol, tert-butanol, n-pentanol, n-hexanol, or else mono-, di-, or trivinyl esters
and mixed methyl ethyl esters.

For the purposes of the present invention, it is also possible to use a mixture composed of a tri- or polycarboxylic acid and one or more of its derivatives. For the purposes of the present invention it is likewise possible to use a mixture of two or more different derivatives of one or more tri- or polycarboxylic acids, in order to obtain the highly branched or hyperbranched polyester.

Examples of diols used for variant (b) of the present invention are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, 1,7-heptanediol, 1,8-octanediol, 1,2-octanediol, 1,9-nonanediol, 1,10-decanediol, 1,2-decanediol, 1,12-dodecanediol, 1,2-dodecanediol, 1,5-hexadiene-3,4-diol, cyclopentanediols, cyclohexanediols, inositol and derivatives, (2)-methylpentane-2,4-diol, 2,4-dimethyl-pentane-2,4-diol, 2-ethylhexane-1,3-diol, 2,5-dimethylhexane-2,5-diol, 2,2,4-trimethyl-pentane-1,3-diol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H or mixtures of two or more representative compounds of the above compounds, where n is a whole number and n≦4. One, or else both, hydroxy groups here in the abovementioned diols may also be replaced by SH groups. Preference is given to ethylene glycol, propane-1,2-diol, and diethylene glycol, triethylene glycol, dipropylene glycol, and tripropylene glycol.

The molar ratio of the molecules A to molecules B in the AₓB_{y} polyester in the variants (a) and (b) is from 4:1 to 1:4, in particular from 2:1 to 1:2.

The at least trihydric alcohols reacted according to variant (a) of the process may have hydroxy groups of which all have identical reactivity. Preference is also given here to at least trihydric alcohols whose OH groups initially have identical reactivity, but where reaction with at least one acid group induces a fall-off in reactivity of the remaining OH groups as a result of steric or electronic effects. By way of example, this applies when trimethylolpropane or pentaerythritol is used.

However, the at least trihydric alcohols reacted according to variant (a) may also have hydroxy groups having at least two different chemical reactivities.

The different reactivity of the functional groups here may derive either from chemical causes (e.g. primary/secondary/tertiary OH group) or from steric causes.

By way of example, the triol may comprise a triol which has primary and secondary hydroxy groups, a preferred example being glycerol.

When the inventive reaction is carried out according to variant (a), it is preferable to operate in the absence of diols and of monohydric alcohols.

When the inventive reaction is carried out according to variant (b), it is preferable to operate in the absence of mono- or dicarboxylic acids.

The process of the invention is carried out in the presence of a solvent. By way of example, hydrocarbons are suitable, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Other solvents very, particularly suitable in the absence of acidic catalysts are: ethers, such as dioxane or tetrahydrofuran, and ketones, such as methyl ethyl ketone and methyl isobutyl ketone.

According to the invention, the amount of solvent added is at least 0.1% by weight, based on the weight of the starting materials used and to be reacted, preferably at least 1% by weight, and particularly preferably at least 10% by weight. It is also possible to use excesses of solvent, based on the weight of starting materials used and to be reacted, e.g. from 1.01 to 10 times the amount. Solvent amounts of more than 100 times the weight of the starting materials used and to be reacted are not advantageous, because the reaction rate decreases markedly at markedly lower concentrations of the reactants, giving uneconomically long reaction times.

To carry out the process preferred according to the invention, operations may be carried out in the presence of a dehydrating agent as additive, added at the start of the reaction. Suitable examples are molecular sieves, in particular 4 Å molecular sieve, MgSO₄, and Na₂SO₄. During the reaction it is also possible to add further dehydrating agent or to replace dehydrating agent by fresh dehydrating agent. During the reaction it is also possible to remove the water or alcohol formed by distillation and, for example, to use a water trap.

The process may be carried out in the absence of acidic catalysts. It is preferable to operate in the presence of an acidic inorganic, organometallic, or organic catalyst, or a mixture composed of two or more acidic inorganic, organometallic, or organic catalysts.

For the purposes of the present invention, examples of acidic inorganic catalysts are sulfuric acid, phosphoric acid, phosphonic acid, hypophosphorous acid, aluminum sulfate hydrate, alum, acidic silica gel (pH=6, in particular =5), and acidic aluminum oxide. Examples of other compounds which can be used as acidic inorganic catalysts are aluminum compounds of the general formula Al(OR)₃ and titanates of the general formula Ti(OR)₄, where each of the radicals R may be identical or different and is selected independently of the others from

C₁-C₁₀-alkyl radicals, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, and n-decyl,

C₃-C₁₂-cycloalkyl radicals, such as cyclopropyl, cyclobutyl, cyclopentyl, cyclohexyl, cycloheptyl, cyclooctyl, cyclononyl, cyclodecyl, cycloundecyl, and cyclododecyl; preference is given to cyclopentyl, cyclohexyl, and cycloheptyl.

Each of the radicals R in Al(OR)₃ or Ti(OR)₄ is preferably identical and selected from isopropyl or 2-ethylhexyl.

Examples of preferred acidic organometallic catalysts are selected from dialkyltin oxides R₂SnO, where R is defined as above. A particularly preferred representative compound for acidic organometallic catalysts is di-n-butyltin oxide, which is commercially available as “oxo-tin”, or di-n-butyltin dilaurate.

Preferred acidic organic catalysts are acidic organic compounds having, by way of example, phosphate groups, sulfonic acid groups, sulfate groups, or phosphonic acid groups. Particular preference is given to sulfonic acids, such as para-toluenesulfonic acid. Acidic ion exchangers may also be used as acidic organic catalysts, e.g. polystyrene resins comprising sulfonic acid groups and crosslinked with about 2 mol % of divinylbenzene.

It is also possible to use combinations of two or more of the abovementioned catalysts.

It is also possible to use an immobilized form of those organic or organometallic, or else inorganic catalysts which take the form of discrete molecules.

If the intention is to use acidic inorganic, organometallic, or organic catalysts, according to the invention the amount used is from 0.1 to 10% by weight, preferably from 0.2 to 2% by weight, of catalyst.

The process for the preparation of the highly branched or hyperbranched polyesters is preferably carried out under inert gas, e.g. under carbon dioxide, nitrogen, or a noble gas, among which mention may particularly be made of argon.

The process for the preparation of the highly branched or hyperbranched polyesters is preferably carried out at temperatures of from 60 to 200° C. It is preferable to operate at temperatures of from 130 to 180° C., in particular up to 150° C., or below that temperature. Maximum temperatures up to 145° C. are particularly preferred, and temperatures up to 135° C. are very particularly preferred.

The pressure conditions for the process for the preparation of the highly branched or hyperbranched polyesters are not critical per se. It is possible to operate at markedly reduced pressure, e.g. at from 10 to 500 mbar. The process of the invention may also be carried out at pressures above 500 mbar. Reaction at atmospheric pressure is preferred for reasons of simplicity; however, conduct at slightly increased pressure is also possible, e.g. up to 1200 mbar. It is also possible to operate at markedly increased pressure, e.g. at pressures up to 10 bar. However, reaction at atmospheric pressure is preferred.

The reaction time for the process for the preparation of the highly branched or hyperbranched polyesters is usually from 10 minutes to 25 hours, preferably from 30 minutes to 10 hours, and particularly preferably from 1 to 8 hours.

Once the reaction has ended, the highly functional hyperbranched polyesters can easily be isolated, e.g. by removing the catalyst by filtration and concentrating the mixture, the concentration process here usually being carried out at reduced pressure. Other work-up methods with good suitability are precipitation after addition of water, followed by washing and drying.

The highly branched or hyperbranched polyester can also be prepared in the presence of enzymes or decomposition products of enzymes (according to DE-A 101 63163). For the purposes of the present invention, the term acidic organic catalysts does not include the dicarboxylic acids reacted according to the invention.

It is preferable to use lipases or esterases. Lipases and esterases with good suitability are Candida cylindracea, Candida lipolytica, Candida rugosa, Candida antarctica, Candida utilis, Chromobacterium viscosum, Geotrichum viscosum, Geotrichum candidum, Mucor javanicus, Mucor miehei, pig pancreas, pseudomonas spp., pseudomonas fluorescens, Pseudomonas cepacia, Rhizopus arrhizus, Rhizopus delemar, Rhizopus niveus, Rhizopus oryzae, Aspergillus niger, Penicillium roquefortii, Penicillium camembertii, or esterase from Bacillus spp. and Bacillus thermoglucosidasius. Candida antarctica lipase B is particularly preferred. The enzymes listed are commercially available, for example from Novozymes Biotech Inc., Denmark.

The enzyme is preferably used in immobilized form, for example on silica gel or Lewatit®. The processes for immobilizing enzymes are known per se, e.g. from Kurt Faber, “Biotransformations in organic chemistry”, 3rd edition 1997, Springer Verlag, Chapter 3.2 “Immobilization” pp. 345-356. Immobilized enzymes are commercially available, for example from Novozymes Biotech Inc., Denmark.

The amount of immobilized enzyme used is from 0.1 to 20% by weight, in particular from 10 to 15% by weight, based on the total weight of the starting materials used and to be reacted.

The process for the preparation of the highly branched or hyperbranched polyesters is carried out at temperatures above 60° C. It is preferable to operate at temperatures of 100° C. or below that temperature. Preference is given to temperatures up to 80° C., very particular preference is given to temperatures of from 62 to 75° C., and still more preference is given to temperatures of from 65 to 75° C.

The process for the preparation of highly branched or hyperbranched polyesters is carried out in the presence of a solvent. Examples of suitable solvents are hydrocarbons, such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene and ortho- and meta-dichlorobenzene. Other very particularly suitable solvents are: ethers, such as dioxane or tetrahydrofuran, and ketones, such as methyl ethyl ketone and methyl isobutyl ketone.

The amount of solvent added is at least 5 parts by weight, based on the weight of the starting materials used and to be reacted, preferably at least 50 parts by weight, and particularly preferably at least 100 parts by weight. Amounts of more than 10 000 parts by weight of solvent are undesirable, because the reaction rate decreases markedly at markedly lower concentrations, giving uneconomically long reaction times.

The process for the preparation of highly branched or hyperbranched polyesters is carried out at pressures above 500 mbar. Preference is given to reaction at atmospheric pressure or slightly increased pressure, for example at up to 1200 mbar. It is also possible to operate under markedly increased pressure, for example at pressures up to 10 bar. Reaction at atmospheric pressure is preferred.

The reaction time for the process for the preparation of the highly branched or hyperbranched polyesters in the presence of enzymes or decomposition products of enzymes is usually from 4 hours to 6 days, preferably from 5 hours to 5 days, and particularly preferably from 8 hours to 4 days.

Once the reaction has ended, the highly functional hyperbranched polyesters can be isolated, e.g. by removing the enzyme by filtration and concentrating the mixture, this concentration process usually being carried out at reduced pressure. Other work-up methods with good suitability are precipitation after addition of water, followed by washing and drying.

The highly functional, hyperbranched polyesters prepared in the presence of enzymes or decomposition products of enzymes feature particularly low contents of discolored and resinified material.

The inventive polyesters have a molar mass M_{W} of from 500 to 50 000 g/mol, preferably from 1000 to 0.20 000 g/mol, particularly preferably from 1000 to 19 000 g/mol. The polydispersity is from 1.2 to 50, preferably from 1.4 to 40, particularly preferably from 1.5 to 30, and very particularly preferably from 1.5 to 10. They are usually very soluble, i.e. clear solutions can be prepared using up to 50% by weight, in some cases even up to 80% by weight, of the inventive polyesters in tetrahydrofuran, n-butyl acetate, ethanol, and numerous other solvents, with no gel particles detectable by the naked eye.

The inventive highly functional hyperbranched polyesters are carboxy-terminated, carboxy- and hydroxy-terminated, and preferably hydroxy-terminated.

The ratios of the highly branched or hyperbranched polycarbonate to the highly branched or hyperbranched polyester are preferably from 1:20 to 20:1, in particular from 1:15 to 15:1, and very particularly from 1:5 to 5:1 if a mixture of these is used.

The hyperbranched polycarbonates and/or hyperbranched polyesters used are nanoparticles. The size of the particles in the compounded material is from 20 to 500 nm, preferably from 50 to 300 nm. Compounded materials of this type are available commercially, e.g. in the form of Ultradur® high speed. The proportion of highly branched or hyperbranched polycarbonate, or highly branched or hyperbranched polyester, or a mixture of these, in the polymer material comprising at least one filler for reinforcement is preferably in the range from 0.1 to 2% by weight. The proportion of highly branched or hyperbranched polycarbonate, or highly branched or hyperbranched polyester, or a mixture of these is particularly preferably in the range from 0.4 to 0.9% by weight.

The molding composition can moreover comprise thermoplastic polyester elastomers. The proportion of the thermoplastic polyester elastomers is preferably up to 15% by weight.

Polyester elastomers here are segmented copolyetheresters which comprise long-chain segments generally deriving from poly(alkylene)ether glycols and comprise short-chain segments deriving from low-molecular-weight diols and dicarboxylic acids.

Products of this type are known per se and are described in the literature. Merely by way of example, reference may be made here to the U.S. Pat. Nos. 3,651,014, 3,784,520, 4,185,003, and 4,136,090, and also to some publications by G. K. Hoeschele (Chimia 28, (9), 544 (1974); Angew. Makromolek. Chemie 58/59, 299-319 (1977), and Pol. Eng. Sci. 1974, 848). Corresponding products are also obtainable commercially as Hytrel® (DuPont), Arnitel® (Akzo), and also Pelprene® (Toyobo Co. Ltd.).

The molding composition can moreover comprise further additives and processing aids.

Examples of usual additives and processing aids used are esters or amides of saturated or unsaturated aliphatic carboxylic acids having from 10 to 40 carbon atoms, preferably from 16 to 22 carbon atoms, with aliphatic saturated alcohols or amines having from 2 to 40 carbon atoms, preferably from 2 to 6 carbon atoms.

The carboxylic acids may be monobasic or dibasic. Examples which may be mentioned as suitable are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines may be mono-, di- or triamines. Examples of these are stearylamine, ethylenediamine, propylenediamine, hexamethylenediamine, di(6-aminohexyl)amine, particular preference being given to ethylenediamine and hexamethylenediamine. Correspondingly, preferred esters or amides are glyceryl distearate, glyceryl tristearate, ethylenediamine distearate, glyceryl monopalmitate, glyceryl trilaurate, glyceryl monobehenate, and pentaerythrityl tetrastearate.

It is also possible to use mixtures of various esters or amides, or esters combined with amides, the mixing ratio here being as desired.

Examples of other conventional additives are elastomeric polymers, also often termed impact modifiers, elastomers, or rubbers.

These are very generally copolymers preferably composed of at least two of the following monomers: ethylene, propylene, butadiene, isobutene, isoprene, chloroprene, vinyl acetate, styrene, acrylonitrile, and acrylates and, respectively, methacrylates having from 1 to 18 carbon atoms in the alkyl component.

The at least one extruded or injection-molded molding composed of the molding composition comprising at least one filler has preferably an E-modulus bigger than 8000 n/mm², particularly bigger than 10000 N/mm², a softening temperature bigger than 100° C., particularly bigger than 150° C. and a strain modulus less than 6·10⁻⁵ K⁻¹, preferably less than 5·10⁵ K⁻¹ and particularly less than 4·10⁻⁵ K⁻¹.

In one embodiment of the invention, the at least one extruded or injection-molded molding composed of the molding composition comprising at least one filler has been placed within a cavity of a hollow profile. The internal cross section of the hollow profile here preferably corresponds to the external cross section of the profile placed within the hollow profile. The extruded or injected-molded molding composed of the molding composition comprising the at least one filler is thus in contact with the hollow profile and can reinforce the same. The cavity of the hollow profile here can assume any desired cross section. The cross section is usually rectangular. However, depending on the function of the profile, it is also possible to use any other desired cross section.

The extruded or injection-molded molding composed of the molding composition comprising the at least one filler here can itself also have been designed as a hollow profile, or else can be solid. A hollow profile gives a further saving in weight in comparison with a solid form. However, the strength of a hollow profile is generally lower than that of a solid profile.

The hollow profile reinforced by having, within a cavity, the extruded or injection-molded molding composed of the molding composition comprising the at least one filler can comprise one or more cavities. If the hollow profile comprises a plurality of cavities, it is possible that the profile composed of the molding composition comprising the at least one filler has been placed within one cavity or within a plurality of cavities. If extruded or injection-molded moldings composed of the molding composition comprising at least one filler have been placed in a plurality of cavities, the extruded or injection-molded moldings composed of the molding composition comprising the filler can respectively have the same cross section or different cross sections. The cross sections of the extruded or injection-molded moldings composed of the molding composition comprising the at least one filler depend here on the geometry of the hollow profile.

In order by way of example to permit production of the hollow profile by an extrusion process, it is preferable to manufacture this from a thermoplastic. Any thermoplastic known to the person skilled in the art is suitable here for the production of the hollow profile. Examples of suitable thermoplastics for the production of the hollow profile are polyolefins, polyvinyl compounds, polyacrylates, polyamides, polyacetals, polyesters, polycarbonates, and cellulose derivatives.

Examples of suitable polyolefins are polyethylene, polypropylene, polybutylene, polytetrafluoroethene, and, polytrifluorochloroethene. Examples of suitable polyvinyl compounds are polyvinyl chloride, polyvinylidene chloride, polystyrene, styrene-acrylonitrile copolymers, acrylonitrile-butadiene-styrene copolymers, acrylonitrile-styrene-acrylate, polyvinylcarbazole, polyvinyl acetate, polyvinyl alcohols, polyvinyl acetals, and polyvinyl ethers.

Examples of suitable polyacrylates are polyacrylic esters, polymethacrylic esters, such as polymethyl methacrylate, polyacrylonitrile, and a copolymer composed of methyl methacrylate and acrylonitrile. Examples of polyamides usually used are nylon-6, nylon-11, nylon-6,6, nylon-6,10, nylon-6,12, and polyurethanes.

An example of a suitable polyacetal is polyoxymethylene.

Examples of suitable polyesters are polyterephthalates.

Examples of cellulose derivatives that can be used are regenerated cellulose, ethylcellulose, cellulose acetate, cellulose triacetate, cellulose propionate, cellulose acetobutyrate, or cellulose nitrate.

Polyvinyl chloride is particularly preferred when the system is used for frames, for example of solar collectors, of boards, of display screens, or of windows or doors.

The thermoplastic from which the hollow profile has been molded is generally unreinforced. However, it is also possible that the thermoplastic from which the hollow profile has been formed also has reinforcement. If the thermoplastic from which the hollow profile has been manufactured has reinforcement, the constitution of the thermoplastic then preferably corresponds to the constitution of the molding composition comprising the at least one filler for reinforcement.

For production of the system, the molding composition comprising the at least one filler for reinforcement is preferably molded through an extrusion process to give the molding.

The extrusion process generally used is an extrusion process which can produce continuous profiles. The reciprocating-screw machines known to the person skilled in the art are generally used to carry out the process. These reciprocating-screw machines generally comprise at least one feed zone, one transition zone, and one metering zone.

The molding composition is generally added in the form of pellets in the feed zone of the reciprocating-screw machine. To this end, the feed zone comprises an inlet aperture. The inlet aperture can have any desired metering apparatus known to the person skilled in the art. Alongside addition of pellets, however, another possible alternative is to add a material which has previously been melted. If the molding composition comprises a plurality of components, these can be added either together or separately. In the case of separate addition, addition can take place by way of a shared inlet aperture or by way of separate inlet apertures. Another possibility is therefore, for example, for addition of a plurality of components, to provide a plurality of feed zones. These can be directly successive feed zones, or there can be a transition zone between each feed zone.

If the molding composition is added in the form of pellets, the pellets are compacted in the feed zone. The feed zone is followed by a transition zone, in which the molding composition is plastified. At the same time, homogenization takes place.

For removal, if appropriate, of residual solvent residues or monomer units comprised within the molding composition, the extruder can comprise at least one vent. Gaseous constituents of the molding composition are removed by way of the vent.

In the metering zone, which follows the transition zone, further homogenization of the molding composition takes place, and compaction to discharge pressure. This pressure is used to force the molding composition through a die. The die is generally one whose cross section corresponds to the cross section of the extruded molding to be produced.

Reciprocating-screw machines used for extrusion processes generally comprise one or more screws. Reciprocating-screw machines usually used comprise one or two screws. However, it is also possible to use more than two screws. If more than two screws are used, the arrangement of these can by way of example take the form of a planetary arrangement with a central screw and screws arranged around the central screw. When reciprocating-screw machines with two screws are used, these may corotate or counter-rotate. Reciprocating-screw machines with two corotating screws are usually used.

Extruders with a screw are preferably used for the production of the profile of the invention. Suitable types of screw are particularly three-zone screws or barrier screws.

Alongside the use of a reciprocating-screw machine it is also possible to use any other desired plastifying apparatus known to the person skilled in the art.

As an alternative to an extrusion process, it is also possible to produce the molding by way of example by an injection-molding process. Reciprocating-screw machines are also usually used for injection-molding processes. However, as well as a reciprocating-screw machine it is also possible to use a melt pump, for example.

If the extruded or injection-molded molding composed of the molding composition comprising the at least one filler has been placed within a cavity of a hollow profile, it is possible, in a first embodiment of the production of the profile system, to insert the extruded or injection-molded molding composed of the molding composition comprising the at least one filler for reinforcement into a cavity of a hollow profile. Good dimensional accuracy is required here, not only of the cavity but also of the profile to be inserted, in order to achieve sufficient reinforcement. As an alternative, it is also possible to use a polymer to fill the remaining cavity between the extruded or injection-molded molding and the hollow profile. Particular preference is given here to polymer foams, which can, if appropriate, have reinforcement. This gives secure bonding of the hollow profile to the extruded or injection-molded molding composed of the molding composition comprising the at least one filler for reinforcement.

The hollow profile here can comprise one cavity or a plurality of cavities, i.e. can be a multichamber profile. In this case, the cavities are usually designed to be adjacent to each other over the entire length of the profile, but there may also be closed chambers provided which do not extend over the entire length of the hollow profile.

However, in one particularly preferred variant of the process, a coextrusion process is used to mold the hollow profile and, comprised within a cavity of the hollow profile, the extruded or injection-molded molding composed of the molding composition comprising the at least one filler. Any desired coextrusion process known to the person skilled in the art can be used here. Coextrusion processes usually use at least two reciprocating-screw machines, and a component is plastified here in each reciprocating-screw machine. In the case of a hollow profile which comprises only one profile composed of the molding composition comprising the at least one filler, the polymer of the hollow profile is plastified in one reciprocating-screw machine, and the molding composition comprising the filler is plastified in the other reciprocating-screw machine. The two reciprocating-screw machines generally have connection to a die, and one operation therefore produces the hollow profile already comprising, in a cavity, the molding composed of the molding composition comprising the at least one filler. An advantage of the coextrusion process is that the molding composed of the molding composition comprising the at least one filler has been placed with precise fit within the cavity. A stable connection of the hollow profile and the extruded or injection-molded molding composed of the molding composition comprising at least one filler is achieved for example by bonding the extruded or injection-molded molding composed of the molding composition comprising at least one filler and the hollow profile at the top end and the root end.

If the intention is that a plurality of moldings composed of the molding composition comprising the at least one filler be inserted into a plurality of cavities of the hollow profile, it is possible, if all of the moldings are produced from the same molding composition comprising the filler, to use one reciprocating-screw machine to plastify the molding composition comprising the at least one filler. However, it is also possible to use a dedicated reciprocating-screw machine for each individual molding composed of the molding composition comprising the at least one filler. Particularly if the moldings composed of the molding composition comprising the at least one filler have different constitutions of the molding composition, it is preferable to use a reciprocating-screw machine for each molding.

Particularly if the intention is to bond at least two extruded or injection-molded moldings to one another for a profile system, these are preferably bonded to one another through a welding process. The extruded or injection-molded moldings here can be bonded to one another at any desired angle with respect to one another. Particularly if at least two hollow profiles which respectively comprise, in at least one cavity, at least one extruded or injection-molded molding composed of the molding composition comprising the at least one filler are bonded to one another, the items bonded to one another by the welding process are not only the hollow profiles but also the extruded or injection-molded moldings composed of the molding composition comprising the at least one filler. This gives additional stability. Particularly in comparison with hollow profiles which by way of example comprise metal inserts for reinforcement, this method can produce systems having better reinforcement.

Alongside the welding process for the bonding of at least two extruded or injection-molded moldings composed of the molding composition comprising the at least one filler, or of at least two hollow profiles which comprise, in at least one cavity, at least one extruded or injection-molded molding composed of the molding composition comprising the at least one filler, these can also be bonded to one another by any desired other processes known to the person skilled in the art. However, welding processes are particularly preferred for achieving stable bonds.

The system of the invention is used by way of example for the production of frames for windows or doors, i.e. window frames, door frames, or door- or window-leaf frames, for protective covering panels, for divider panels, for partition walls, for ceiling panels, for frames, e.g. for solar collectors, where solar collectors comprise not only photovoltaic systems but also systems for the heating of water, or for boards or for display screens; for furniture, e.g. shelving components, chair components, tables; for frameworks or support frames, e.g. in mining, for cladding for cable ducts or cable trunking, roofracks for motor vehicles, or crossmembers for roof structures. The system of the invention is also suitable for the production of reinforcement for wall panels.

The invention is shown in the drawings below, taking the example of a simple profile.

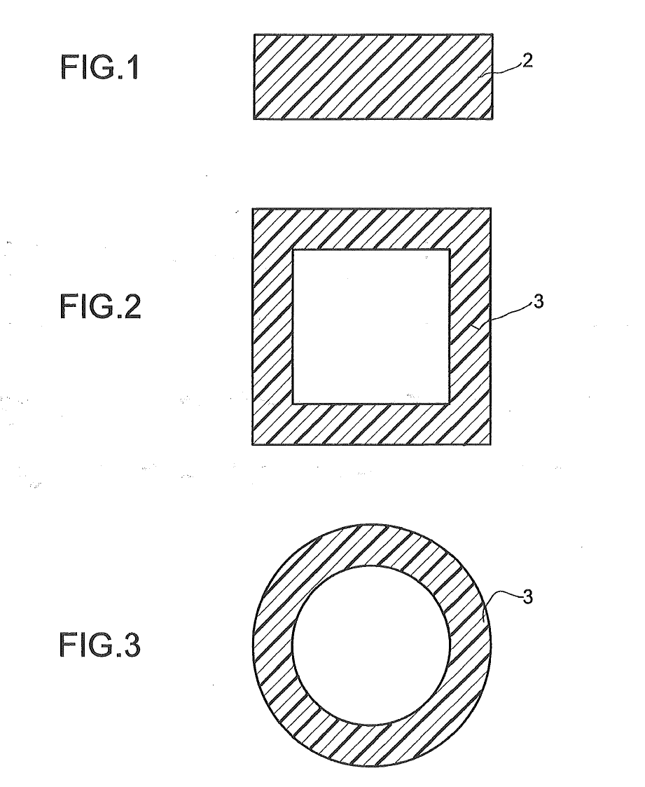

FIG. 1 shows a section through a solid profile with rectangular cross section,

FIG. 2 shows a section through a hollow profile with rectangular cross section,

FIG. 3 shows a section through a hollow profile with circular cross section,

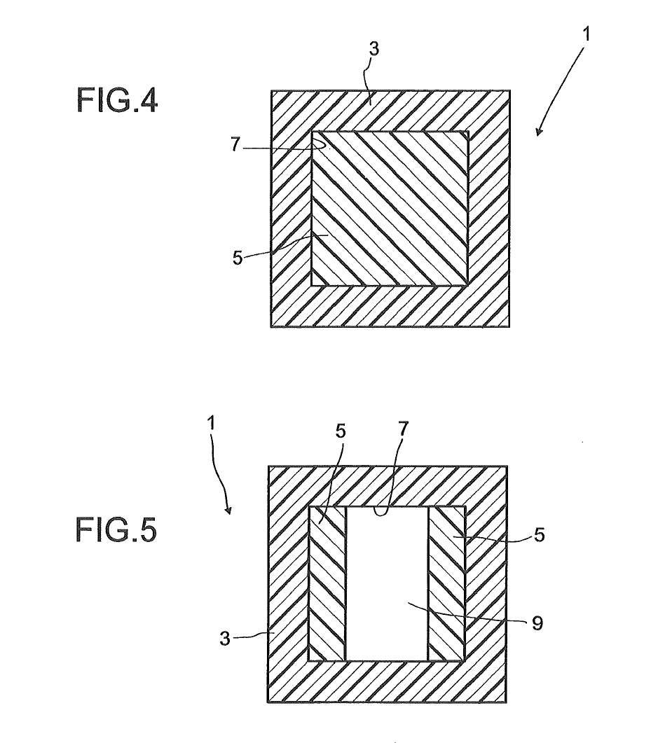

FIG. 4 shows a section through a rectangular profile with reinforcement, in a first embodiment,

FIG. 5 shows a section through a rectangular profile with reinforcement, in a second embodiment.

FIG. 1 shows a section through a solid profile with rectangular cross section.

A solid profile 2 is extruded or injection-molded from a molding composition comprising a polymer material. The molding composition also comprises at least one filler for reinforcement. The solid profile 2 can have not only the rectangular cross section shown here but also any desired other cross section. By way of example, the cross section can therefore also be circular, elliptical, or triangular, or take the form of a polygon with any desired number of corners. The cross section can also, for example, have undercuts or ribs.

FIGS. 2 and 3 respectively show hollow profiles. FIG. 2 shows a hollow profile 3 designed as a rectangular profile. FIG. 3 shows a hollow profile 3 with a circular cross section.

Alongside the rectangular cross section of FIG. 2 or the round cross section shown in FIG. 3, it is also possible to design the hollow profile 3 with any desired other cross section. It is also possible that the hollow profile 3 has, for example, ribs. The shape of the hollow profile 3 here depends on the application sector of the profile.

In order to achieve sufficient stiffness of the solid profile 2 or the hollow profile 3, the solid profile 2 or the hollow profile 3 has been manufactured from a molding composition which comprises a polymer material having at least one filler for reinforcement. The proportion of the filler for reinforcement here is in the range from 20-80% by weight. The polymer material used usually comprises a thermoplastic, for example a polyester, a polyamide, a polyvinyl chloride, polyvinylidene chloride, polypropylene, polycarbonate, styrene-acrylonitrile copolymer, acrylonitrile-butadiene-styrene copolymer, acrylonitrile-styrene-acrylate, or polyoxymethylene. Preferred polymer materials are polybutylene terephthalate, polyethylene terephthalate, or polytrimethylene terephthalate. The filler which has been used to reinforce the polymer material preferably takes the form of fibers. Examples of suitable fibers are glass fibers, carbon fibers, aramid fibers, and potassium titanate fibers. The length of the fibers is usually from 0.1 to 0.4 mm. In order to achieve improved extrudability of the molding composition, this preferably also comprises at least one highly branched or hyperbranched polycarbonate, at least one highly branched or hyperbranched polyester, or a mixture of these.

FIG. 4 shows a system designed in the invention with a hollow profile, within which a molding has been placed, in a first embodiment.

A system 1 designed in the invention comprises a hollow profile 3. In the embodiment shown here, the hollow profile has been designed as a rectangular profile. However, the hollow profile 3 can also assume any desired other shape, as well as the rectangular design of the hollow profile 3 shown here. By way of example, therefore, it is possible for the hollow profile 3 to assume a circular cross section, an elliptical cross section, a triangular cross section, or else a cross section in the form of a polygon with any desired number of corners. If the hollow profile 3 has been designed in the form of a polygon with 3 or more corners, the edge lengths can respectively be identical or different.

In the embodiment shown here, the hollow profile 3 comprises a cavity, within which an extruded or injection-molded molding 5 has been placed. All sides of the extruded or injection-molded molding 5 here are flush with, and enclosed by, the hollow profile 3. The extruded or injection-molded molding 5 is thus fixed within the hollow profile 3.

In order to secure the extruded or injection-molded molding 5 within the hollow profile 3, this may, for example, be welded into position, adhesive-bonded into position, or bonded in any other desired manner known to the person skilled in the art to the hollow profile 3. An example of another possibility inserts an extruded or injection-molded molding 5 into the hollow profile 3 and uses a polymer material, preferably a polymer foam, to fill cavities formed between the hollow profile 3 and the extruded or injection-molded molding 5.

Another possibility, alongside the embodiment shown here with a hollow profile 3 with a cavity filled by an extruded or injection-molded molding 5, is to use a hollow profile 3 with a plurality of cavities. Again, these cavities can assume not only the square shape shown here but also any other desired shaped. An example of another possibility has ribs protruding into the cavity. If all sides of the extruded or injection-molded molding 5 are in contact with the walls 7 surrounding the cavity in the hollow profile 3, the cross section of the extruded or injection-molded molding 5 corresponds to the cross section of the cavity.

Another possibility for placing of the extruded or injection-molded molding 5, is that pockets have been designed within the cavity, and the extruded or injection-molded molding 5 has been inserted into these. In this case, it is preferable that the pockets enclose the respective sides of the extruded or injection-molded molding 5.

By way of example, a coextrusion process can be used to manufacture the system 1. The coextrusion process here produces the hollow profile 3 and the extruded molding 5 in one operation.

As an alternative, it is also possible by way of example to begin by manufacturing the hollow profile 3 by an extrusion process and to insert, into the cavity of the hollow profile 3, the extruded or injection-molded molding 5 composed of the molding composition comprising the at least one filler. The molding 5 here is generally produced by an extrusion process or injection-molding process, as a function of its shape and length.

FIG. 5 shows an alternative embodiment for a system 1 designed in the invention.

The system 1 shown in FIG. 5 likewise comprises a rectangular hollow profile 3. In contrast to the hollow profile shown in FIG. 4, the rectangular hollow profile 3 comprises a cavity 9 into which two extruded or injection-molded moldings 5 have been inserted. Three sides of the extruded or injection-molded moldings 5 here in the embodiment shown in FIG. 5 are in contact with the walls 7 of the cavity 9. The extruded or injection-molded moldings here are fixed by, for example, friction or interlock. By way of example, the extruded or injection-molded moldings can be fixed into the cavity 9 by welding, adhesive bonding, or screwing, or in any other manner. Another possibility uses a polymer material, preferably a polymer foam, to fill the remaining cavity 9 not filled by the extruded or injection-molded moldings 5. The embodiment shown in FIG. 5 is also preferably produced by a coextrusion process. The coextrusion process is preferred particularly when any dimensional inaccuracies arising would make it difficult to insert the injection-molded or extruded molding 5.

The hollow profile 3, as shown in FIGS. 4 and 5, is preferably manufactured from polyvinyl chloride. A particularly preferred material for the extruded or injection-molded moldings 5 is a thermoplastic polyester comprising glass fibers as filler. To improve the welding properties of the moldings 5, it is preferable that the molding composition also comprises highly branched or hyperbranched polycarbonates, or highly branched or hyperbranched polyesters, in the form of nanoparticles.

As a function of the geometry of the hollow profile 3, the hollow profiles 3 reinforced by the moldings 5 can be used in any desired applications. These profiles are therefore suitable by way of example for the production of frames for solar collectors, for boards, for display screens, for windows or doors, or for the production of wall panels or of ceiling panels, for the reinforcement of wall panels, for the production of furniture, for example of shelves, chairs, or tables, for the production of frameworks or support frames, such as those used in mining, for the production of cladding for cable ducts or for cable trunking, for the production of roofracks, for example for motor vehicles, and for the production of crossmembers for roof structures.

1.-17. (canceled)

18. A system comprising at least one extruded or injection-molded molding composed of a molding composition comprising a polymer material, where the molding composition comprises at least one filler for reinforcement, wherein the proportion of the filler for reinforcement in the molding composition is in the range from 20 to 80% by weight, wherein the molding composition comprising the at least one filler further comprises at least one highly branched or hyperbranched polycarbonate, at least one highly branched or hyperbranched polyester, or a mixture of these.

19. The system according to claim 18, wherein the polymer material is a thermoplastic.

20. The system according to claim 19, wherein the thermoplastic has been selected from the group consisting of polyester, polyamide, polyvinyl chloride, polyvinylidene chloride, polypropylene, polycarbonate, styrene-acrylonitrile copolymer, acrylonitrile-butadiene-styrene copolymer, acrylonitrile-styreneacrylate, and polyoxymethylene.

21. The system according to claim 20, wherein the polyester is polybutylene terephthalate, polyethylene terephthalate, or polytrimethylene terephthalate.

22. The system according to claim 18, wherein the proportion of highly branched or hyperbranched polycarbonate, highly branched or hyperbranched polyester, or a mixture of these is in the range from 0.1 to 2% by weight.

23. The system according to claim 18, wherein the filler for reinforcement takes the form of fibers.

24. The system according to claim 23, wherein the fibers have been selected from the group consisting of glass fibers, carbon fibers, aramid fibers, and potassium titanate fibers.

25. The system according to claim 23, wherein the length of the fibers is from 0.1 to 0.4 mm.

26. The system according to claim 18, wherein at least one profile composed of the molding composition comprising at least one filler has been placed within a cavity of a hollow profile.

27. The system according to claim 26, wherein the hollow profile has been manufactured from a thermoplastic.

28. The system according to claim 27, wherein the thermoplastic from which the hollow profile has been manufactured is unreinforced.

29. The system according to claim 27, wherein the unreinforced thermoplastic is polyvinyl chloride.

30. A process for the production of a system according to claim 18, which comprises molding the molding composition comprising the at least one filler for reinforcement through an extrusion process to give the molding.

31. The process according to claim 30, wherein the molding composed of the molding composition comprising the at least one filler for reinforcement is inserted into a cavity of a hollow profile.

32. The process according to claim 30, wherein a hollow profile and the molding which is composed of the molding composition comprising the at least one filler and which is comprised within a cavity of the hollow profile are molded through a coextrusion process.

33. The process according to claim 30, wherein at least two moldings composed of the molding composition comprising the at least one filler, or at least two hollow profiles which comprise, within at least one cavity, at least one molding composed of the molding composition comprising the at least one filler are bonded to one another through a welding process.

34. A process for the production of frames for solar collectors, for boards, for display screens, for windows, or for doors, or for the production of reinforcement for wall panels or for ceiling panels, or for the production of furniture, of frameworks, of support frames, of roof racks for motor vehicles, cladding for cable ducts or cable trunking, crossmembers for roof structures, or reinforcement of wall panels which comprises utilizing the system according to claim 18.
